(19) United States
(12) Patent Application Publication
(10) Pub. No.: US 2015/0100376 A1
(43) Pub. Date: Apr. 9, 2015

(54) METHOD AND SYSTEM FOR USING NEUROSCIENCE TO PREDICT CONSUMER PREFERENCE

(71) Applicants: CARNEGIE MELLON UNIVERSITY, Pittsburgh, PA (US); BROWN UNIVERSITY, Providence, RI (US)

(72) Inventors: Sophie Lebrecht, Providence, RI (US); Michael J. Tarr, Pittsburgh, PA (US); David Sheinberg, Barrington, RI (US); Moshe Bar, Ramat Hasharon (IL)

(21) Appl. No.: 14/382,406

(22) PCT Filed: Mar. 4, 2013
(86) PCT No.: PCT/US13/28945

§ 371 Date: Sep. 2, 2014

Related U.S. Application Data
(60) Provisional application No. 61/634,552, filed on Mar. 2, 2012.

(51) Int. Cl. G06Q 30/02

(52) U.S. Cl. CPC G06Q 30/0201
USPC 705/7.29

(57) ABSTRACT

A system and method provides techniques and analysis tools for measuring how individuals perceive and respond to valences and more subtle “micro-valences” present in stimuli. The invention includes a process that uses human neuroimaging and behavioral techniques to measure valence in order to predict how individuals will perceive and react to any stimulus designed to engage individuals, e.g., end users or consumers, including, but not limited to, products, brands, logos, packaging, banner ads, and advertisements and their subcomponents or features, such as shape, color, pattern, and material properties.

### CROSS-REFERENCE TO RELATED APPLICATIONS

This application claims the benefit of priority under 35 U.S.C. §119(e) of U.S. Provisional Patent Application No. 61/634,552, filed Mar. 2, 2012, the entire disclosure of which is hereby incorporated herein by reference.

### STATEMENT OF GOVERNMENT INTEREST

This invention was made with government support under the National Science Foundation Number SMA-1041755. The government has certain rights in this invention.

### BACKGROUND OF THE INVENTION

Affect itself is commonly defined along two continuous dimensions: valence (pleasantness) and arousal (activation). The present invention is primarily focused on the single dimension of valence.

Valence can be broadly defined as the emotional value associated with a stimulus. Everyday objects, such as a coffee mug or the label on a juice carton will likely generate a weaker or more subtle valence response, which the Applicant has identified and refers to as the stimuli's micro-valence. This valence is described as “micro” because the intensity of the response is less than the intensity for a strongly affective stimulus, such as a bloodied weapon or a chocolate cupcake. However, this weak intensity should not be confused with a weak effect. There are many small, yet robust effects; for example Sternberg's (1966) classic digit memory search exhibited an effect of less than 40 milliseconds per an item in memory.

Studies have shown that when making rapid “gut reaction” judgments participants consistently prefer curved over sharp or jagged objects for both familiar and novel objects. Other studies have observed that participants can make valence judgments on simple shapes. At the same time, several studies report more reliable ratings for real-world images as compared to abstract shapes, indicating that experience-based associations are dominant in forming valences.

More plausibly, micro-valences arise from an integration of visual properties and learned associations. Moreover, these two attributes may potentially interact in that it may be easier to form positive associations with objects already possessing “positive” perceptual features. Consider that an observer might more readily generate positive associations with a shiny, curved, symmetrical teapot, whereas the same observer might more readily generate negative associations with a dull, angular, asymmetric teapot. Conversely, there is some evidence that this interaction between perceptual features and associations may also function in reverse. Some studies suggest that color preference might sometimes arise from the degree to which an individual prefers an object with a particular color, so that participants would be more likely to prefer green to yellow if they prefer apples to bananas.

Applicant contends that micro-valences function to optimize one's ability to either select or orientate towards objects with a positive micro-valence and away from those with a negative micro-valence. Throughout the day individuals make multiple unconscious decisions: what mug to use for our morning coffee, what pen to sign with, and what bottle of water to purchase. Applicant submits that these decisions are facilitated by micro-valences computed during perception, which can be used to reduce uncertainty and/or to orientate towards some objects and away from others. Accordingly, it would be desirable to have a method and system for measuring and quantifying how individuals perceive and respond to valences and, more particularly, to the more subtle micro-valences.

### SUMMARY OF THE INVENTION

The claimed invention is directed to a method and system for measuring response to stimuli and, more particularly, provides a method and system for measuring and quantifying how individuals perceive and respond to valences and micro-valences. It enables inferences to be made about an “implicit attitude” that one might have towards a particular stimulus, such as a particular object, a group of objects, a race, and the like. An implicit attitude is defined as a bias of belief held by an individual about the stimuli that is automatically or unconsciously elicited when the stimulus is encountered. In a broad embodiment, the method comprises: exposing at least one individual, via a processing device, to at least one valence-measuring paradigm in which the at least one individual is exposed to a plurality of stimuli and is required to provide a spontaneous, i.e., automatic, response directed to at least one of said plurality of stimuli; calculating a valence value for each of said plurality of stimuli based on each spontaneous response; and storing each valence value in a storage medium. There are multiple paradigms described herein, each of which enable the measurement of valences, and using multiple paradigms in connection with the same stimuli and correlating the resulting valence measurements provides a more robust valence measurement result. Both behavioral response paradigms (behavioral valence measuring techniques) and brain response paradigm (neuroimaging valence measuring techniques using, for example, Magnetic Resonance Imaging (MRI)) are disclosed. The stored valence values can be used to create models useable to predict values for stimuli not yet subjected to the valence valuation process, i.e., any stimuli).

### BRIEF DESCRIPTION OF THE DRAWINGS

FIG. 1 illustrates how valence can be regarded as an object property.

FIG. 2 presents histograms of micro-valence scores generated by each individual in Paradigm 1.

FIG. 3 shows a significant linear correlation between the group average scores from Paradigm 1 and the group average scores from Paradigm 2 [r2=0.76, p=0.0001].

FIG. 4 presents the eight of the most negative and eight of the most positive shapes derived from a valence norming pilot experiment we conducted. The objects grouped under (a) were rated as negative, and the objects grouped under (b) were rated as positive. Note the shape and color consistency across the two different groups.

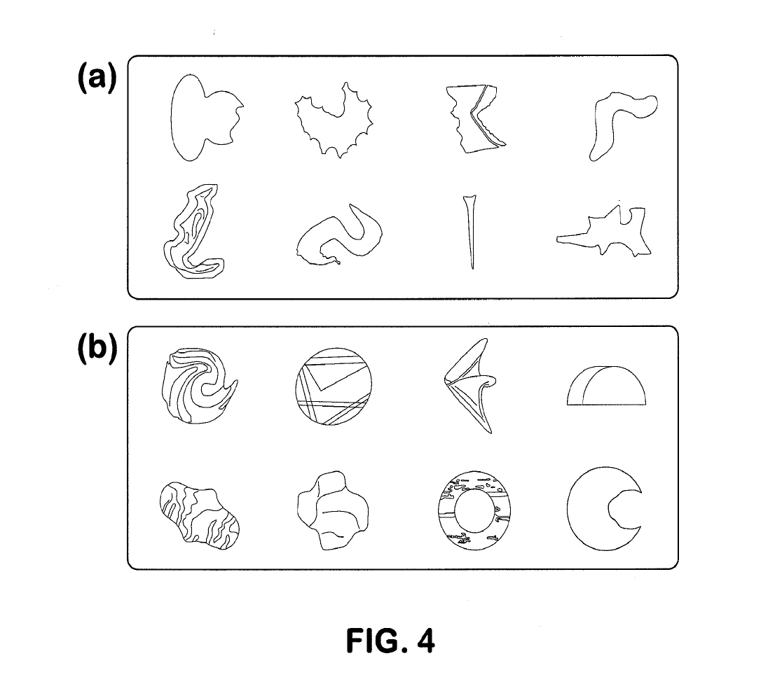

FIG. 5 illustrates a crossover interaction in that demonstrates that participants are faster to make lexical decisions for words where the prime and target match in valence, compared to when they are mismatched.

FIG. 6 presents activation threshold at p<0.05 for SP-SN in green (a) and MP-MN in purple (b) plotted on an inflated left hemisphere.

FIG. 7 graphs the time course activation for all four experimental conditions from an anatomically defined region of interest in left prefrontal cortex.

FIG. 8 shows the location of the Lateral Occipital Cortex (LOC) cluster (a) defined from an objects-scrambled localizer (peak MNI coordinate −42, −78, 9) that is used in the Region of Interest (ROI) analysis presented in (b).

FIG. 9 illustrates how the valence perceived during object recognition relates to decision-making and arousal.

FIG. 10 illustrates a process for using various paradigms and stimuli to organize and analyze data pertaining to consumer preferences.

Table 1. Reports the peak X, Y, and Z co-ordinates for (Strong Positive—Strong Negative) which is indicated as strong in the table and (Micro Positive—Micro Negative) which is indicated as micro in the table. For each cluster we also report the cluster size and t-value. In cases where the participants show either no clusters, or no distinguishable clusters we reported n/a. The two clusters presented in red indicate that they are not significant at p<0.001 uncorrected.

### DETAILED DESCRIPTION OF THE PREFERRED EMBODIMENTS

People perceive stimuli to have a positive or negative valence. This valence can be thought of as a general property of perception and is used, via the claimed invention, to effectively predict choice behavior and decision-making. For stimuli where the valence is less intense (e.g. everyday objects, shapes, colors, patterns, or fragments of objects) it is referred to herein as a “micro” valence. In accordance with the claimed invention, brain and behavior experimental paradigms are used to measure individual's perceptions of valence and micro-valence.

A series of brain (for example, human functional Magnetic resonance Imaging (MRI)) and behavior (for example, computer-based human psychophysics) experiments (trials) are conducted that measure valence, which provides neuropsychological tools to predict consumer preferences to different forms of perceptual information. The signals from the human brain and the individual's behavioral response can be used to predict preference when people are encountering a variety of stimuli and their sub-features (e.g., products, brands, logos, packaging, banner ads, and advertisements, shape, color, pattern, and material properties).

In one aspect of the present disclosure, a method performed by one or more processing devices includes the following: obtaining high-quality end-user (e.g., consumer) testing experimental data indicative of experiments associated with predicting end-user behavior; initializing the information with a result of at least one of the experiments; generating, based on initializing, a model to predict end-user behaviors; selecting, based on the predictions, one or more experiments from the experiments to be executed; executing the one or more experiments.

Implementations of the disclosure can include one or more of the following features. In some implementations, a prediction includes a value indicative of whether a visual entity is predicted to have an effect on a person's preference, choice, decision-making, and action. This valence value can be composed as a valence “score” that can be assigned to the valence.

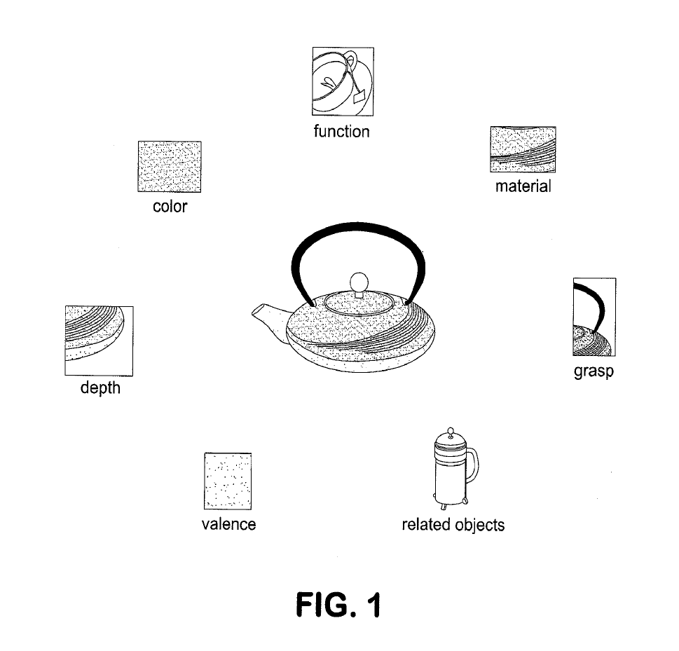

In one embodiment, an object's micro-valence is perceived rapidly, often times without conscious awareness. FIG. 1 illustrates how valence can be regarded as an object property. The example object of a teapot illustrates how valence is not just a feature of objects with a strong and pronounced valence, but is also potentially a property of all every day, seemingly neutral objects.

In one example of this embodiment, hereafter referred to as Paradigm 1 or the “gifting trial”, an individual is prompted to subconsciously and spontaneously (i.e., automatically) report the valence of stimuli (e.g., a visually perceived object) indirectly. Participants select objects that they would most like to keep or return given two or more options. The options could have been given, for example, as birthday gifts, wedding gifts, holiday gifts, reward dividends or any other option that requires the individual to make a choice. The stimuli are presented rapidly, with only a brief response window to encourage participants towards an automatic, and away from a controlled, level of processing. The task in the experiment assesses consistency in response selection both within and across individuals. To that end, each object is repeated multiple times in both tasks.

If desired, the task is replicated in a “keep” condition and a “return” condition and the scores are summed from both tasks. It is the addition of both scores that gives the micro-valence measure.

In Paradigm 1, before starting the task, participants are told, “You have been given a series of options”. In the “keep” condition, participants are told that on any given trial, they would see two or more options and their task was to select the option they would most like to keep. During each trial, in one example, a selection of two or more stimuli, for example, objects or shapes or patterns, are presented simultaneously, and the participant is instructed to compare the stimuli and select the option they would most like to keep by making a button press to indicate the location of the object. Each stimulus is presented for under 1000 milliseconds multiplied by the number of stimuli.

Participants are allowed to respond while the stimuli are on the screen or during a timed response window that follows. Participants are instructed to view all the stimuli and then make their response as quickly and as accurately as possible, based only on the stimuli present in the current trial. In this part of the experiment each stimulus is repeated in unique sets for a minimum number of times. The ordering of set presentations is randomized across participants, but the actual object combinations within a given set are the same across participants. This design allows for consistency assessment across participants.

The “return” condition is identical to the “keep” condition just described, but here participants decide which of the options presented they would most like to return. The “keep” condition is designed to index the positive dimension of micro-valence, whereas the “return” condition is designed to index the negative dimension. The ordering of these two conditions is counter balanced across participants.

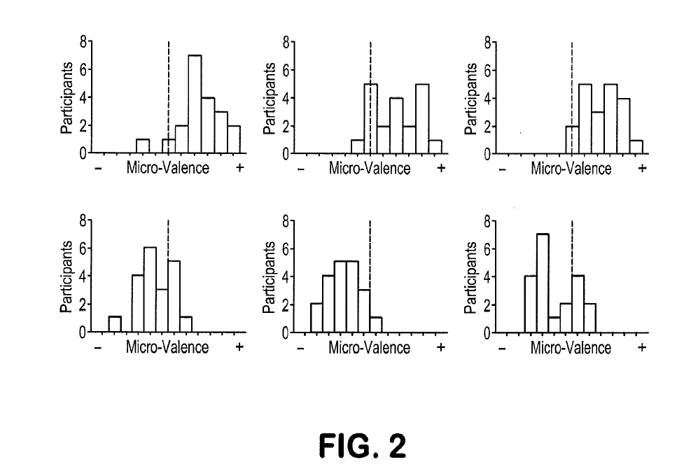

To calculate a stimulus' micro-valence from Paradigm 1, a point is added to a stimulus every time it is selected in the keep condition (or anything that gets at choosing to keep) and subtracted a point every time it is selected in the return condition (or choosing to give back). In one example, if the stimuli are presented five times in each condition, the micro-valence scores range from −5 to +5. In another example, if the objects are presented six times in each condition, the micro-valence scores range from −6 to +6. When participants select stimulus options consistently in the keep condition, then never select on the return condition, it has an overall positive valence score. Likewise, if a stimulus option is consistently selected in the return condition and never picked on the keep condition, it has an overall negative micro-valence score (FIG. 2). FIG. 2 presents histograms of micro-valence scores generated by each individual in Paradigm 1. The horizontal axis represents the score for a given stimuli, and the vertical axis represents the number of participants that rated the stimuli with the particular micro-valence score. Histograms colored in red indicate objects with a distribution significantly skewed towards positive, whereas histograms colored in blue indicate objects with a distribution significantly skewed towards negative. Significance was measured by distributions where the 95% confidence intervals for the distribution did not span zero. The scores for an individual or when averaged across groups of individuals can be used to predict consumer behavior.

In one embodiment, the participants consistently select objects that they perceive to have a positive micro-valence in the keep task, yet rarely select them in the return task. The opposite pattern is examined for response for objects perceived to have a negative micro-valence. While this embodiment has been described primarily in terms of Paradigm 1, those skilled in the art will recognize that the methods of the present invention could also be used for other applications that involve consumer choice.

Another example of this embodiment, Paradigm 2, constitutes a more direct measure of valence. Stimuli are initially presented in a random location on a display screen (e.g., a computer, a projection screen, a tablet, a mobile device, or a TV). The participant is tasked with ordering the images from most positive to most negative along the dimension of valence. From the ranked order, relative valence strengths of each stimulus are computed.

In an attempt to guide participants towards more automatic processing, a timer is used in each trial and participants are instructed to order the objects as quickly as possible based on their initial, automatic assessment of valence. The duration of this timer can vary depending on the specific goals of the task and the number of stimuli presented.

In this example, on a single trial, participants are presented the stimuli randomly assigned to a position on the screen. The participants' task is to rank the stimuli from left to right, with far left being the most negative and far right being the most positive. In some instances, scrolling over a thumbnail of the stimulus with the cursor will enlarge the image to a suitable size dependent on the number of stimuli on the screen and the size of the screen. Participants use the cursor to drag the stimulus to their desired position on screen. If the experiment is presented using touch screen technology, the participant uses a finger to drag the object across the screen. Participants are given a discrete amount of time to complete this task, dependent on the number of stimuli that need to be ordered. At a pre-determined time before their total time elapses, a stopwatch timer is presented in the top left hand corner to indicate to the participant the amount of time remaining.

For every trial, x-y screen pixel co-ordinates are recorded for each stimulus from which ranking positions are assigned. The object in the far left (most negative) position on the screen is assigned a 1, and the object in the far right (most positive) position is assigned the maximum number of images that the trial includes, for example, if there are 12 images total, then the most positive image would receive a score of 12.

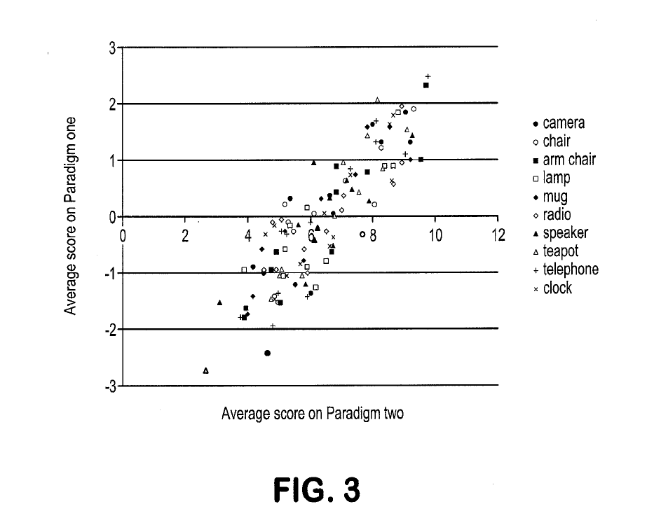

To ensure a more confident measure in the stability of the valence rating for a given object or image, the ranked position number for each image is then correlated with the corresponding score from Paradigm 1. In that, reasonably strong consensus is observed for micro-valence in Paradigm 1, for each object that is used in the group averages to compute a correlation between Paradigm 1 and Paradigm 2. Integrating the values/scores from various Paradigms allows “weighting” of the representation of valence and provides a more distributed representation of valence. FIG. 3 shows a significant linear correlation between the group average scores from Paradigm 1 and the group average scores from Paradigm 2 [r2=0.76, p=0.0001]. Each dot represents the average ratings for a single stimulus on both tasks. Dots are color coded according to their basic level category. The distribution of colored dots indicates the correlation is not driven by a preference for a particular object category.

The results in FIG. 3 show a significant positive correlation between the two tasks [r2=0.76, p=0.0001], indicating that rank ordering the images along a valence continuum is predictive of what images individuals will consistently choose to keep or return in Paradigm 1 that uses choice and decision-making to index micro-valence.

In another example of this embodiment, called Paradigm 3, participants are presented with a single stimulus above an image of a line. The participant is told that the line ranges along the dimension of valence from most negative on the left to most positive on the right. The participant is instructed to use the cursor to click a point on the line that corresponds to how positive or negative they perceive the stimulus. When this is conducted on a touch screen device, participants drag a point along the line to indicate the direction and strength of their perceived valence of the stimulus.

In further example of the embodiment, called Paradigm 4, a process known to those skilled in the art as the Affective Lexical Priming Score (ALPS) (Lebrecht et al 2009) is used, in which participants see a stimulus presented on screen for less than 1000 milliseconds. Following a less than 100 milliseconds inter-stimulus interval the participant is presented with a letter-string that is either a real word (for example, “love”) or a non-word (for example, “malk”). On any given trial, participants are instructed to decide whether the letter string is a real word or a non-word and to make their response as quickly and as accurately as possible. The content of the stimuli varies dependent on the goals of the task. There is always a neutral version of whatever stimulus category is used to ensure that each participant's baseline response time can be calculated and used in the analysis.

Paradigm 4 is about matching the valence of images and words. If the valence matches (even if the image and word are semantically unrelated—i.e. cake and sunshine) individuals are faster to respond when they are making a word or non-word decision. The fact that the stimuli and the task appear unrelated acts as evidence that the process of valence evaluation is automatic (i.e. happens independently of the explicit demands of the task). This is what happens in cognitive experiments measuring “implicit” attitudes. Individuals have a great deal of unconscious knowledge about everything they process. This does not mean the knowledge cannot become conscious; it means that this knowledge influences our behavior even if it is not conscious. So there is a valence associated with the prime image and, similarly, there is a valence associated with each and every word we know. To the extent that these properties are the same between the prime image and the word, the word is processed faster even though the judgment is simply “word/non-word” and seems unrelated to the variable of interest. This is significantly different than standard “ask people what they think” consumer surveys.

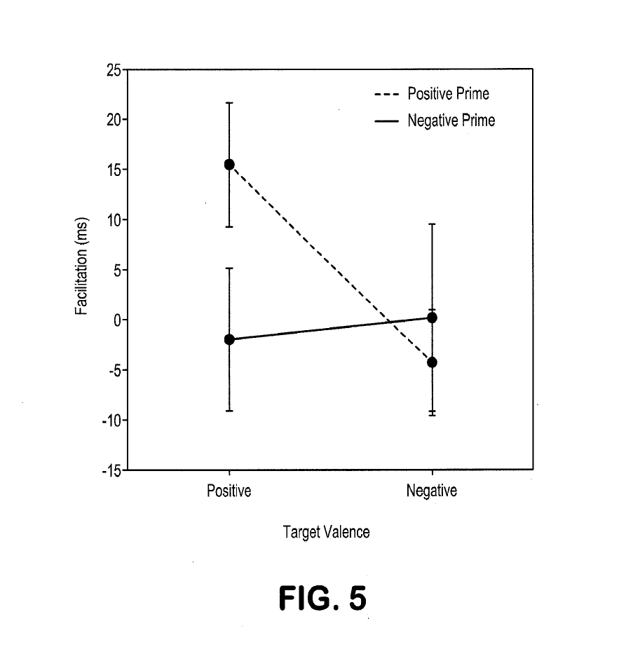

The response time for each trial is calculated and then subtracted from the participant's baseline, which is calculated from their response time in neutral trials. The response times are averaged across conditions to determine the strength of association between the stimulus and the word (FIG. 5). FIG. 5 illustrates a crossover interaction which demonstrates that participants are faster to make lexical decisions for words where the prime and target match in valence, compared to when they are mismatched. In this graph, target word valence is presented on the horizontal axis and prime valence is indicated by either a dashed line for positive object primes or a solid line for negative object primes. The facilitation in response time is measured in milliseconds and represented on the vertical axis; it is computed by subtracting response times from a neutral word baseline. Scores above zero indicate a facilitated response, whereas scores below zero indicate an inhibited response.

While Paradigms 1 through 4 have been described primarily in terms of embodiments using behavioral tasks, those skilled in the art will recognize that the methods of the present invention could also be used in touch screen technology.

In one embodiment, Paradigm 5, functional neuroimaging is used to identify the perception of valence as coded in the human brain. This paradigm takes advantage of the fact that valence operates along a continuum, which is measured using the Blood Oxygen Level Dependent (BOLD) response from human functional magnetic resonance imaging (fMRI). Applicant separates out fine grain differences in the BOLD response that correspond to differences in the perceived valence of the stimuli and uses these differences to predict consumer perceptions and choice patterns and behaviors. In one embodiment, this paradigm involves the use of an experiment set up as follows: whilst in an MRI machine, participants are presented with a single stimulus for less than 1000 milliseconds in the center of a white screen and asked to rate it for pleasantness on a 1-4 scale using a response box. Participants are able to respond while the stimulus is on the screen, or during a timed response window that follows (this may vary depending on the overall structure of the trial). Trials are separated by a 12 second Inter-Trial Interval (ITI), during which time participants focus on a central red fixation cross.

The fMRI procedure can include a number of experimental runs that vary dependent on the total number of stimuli in the experiment. Runs containing stimuli that generate a micro-valence perception occur first in the experimental session, followed by stimuli that generate the perception of a stronger valence. Within a given run of this type the presentation of positive and negative objects are randomized. Participants are given the task instructions outside of the MRI machine, but at the beginning of each run an instruction screen is presented for, in one example, 10 seconds as a reminder. The instruction screen is followed by 10 seconds of fixation before the onset of the first trial.

In one example, Paradigm 6, stimuli are presented every second in blocks that can vary from 12 to 18 seconds; these blocks are followed by blocks of fixation that may vary from 6 to 8 seconds. Each block contains repetitions of the same stimulus identity, sometimes at variations in viewpoint, size, and location on the screen in an effort to reduce habituation of the BOLD signal during stimulus repetitions. Paradigm 6 shares the same goals as Paradigm 5, with the additional goal of being able to read out the valence activation that corresponds to the valence perception for a single stimulus so that it can be compared to other closely related stimuli.

In order to locate the bilateral regions in prefrontal cortex that code for valence two separate functional localizers are performed: one that locates object processing and another that locates affective processing. The neural localization of these functional regions varies across individuals, so in addition to locating these locations for an individual, it may also be desirable to take a group average to get a sense of the population response. Thus, the present invention can include localization within a particular individual, generation of a group map across individuals, and generalizing localization from the group results to new individuals. This allows predictions to be made for people not tested.

Once these regions have been located using an unbiased method, they can then be used in subsequent analyses. The object and affect localizer are identical with the only exception being that different stimuli are presented. For each localizer, there is one run that contains 12 sixteen-second blocks separated by 6 seconds of fixation. Single stimuli are presented in the center of a white screen, while participants are instructed to look for an identical stimuli match based on the preceding or upcoming stimulus. The object localizer always precedes the affect localizer, and the experimental runs always precede both localizer scans. The Region of Interest (ROI) in the bilateral regions of the Inferior Frontal Sulcus located in the prefrontal cortex can be localized from these type of scans by subtracting activation from any of the following: stimuli minus their phase scrambled counter parts; positive stimuli minus negative stimuli; positive stimuli minus neutral stimuli; negative stimuli minus neutral stimuli.

In one example, for both Paradigm 5 and 6, an fMRI method is used. A whole brain imaging is performed on, in one example, a Siemens 3 Tesla TIM Trio MRI Scanner, in another example a Siemens Verio 3 Tesla Scanner (other MRI machines with a minimum Tesla of 3.0 work equally well for this process). In one example, at the start of the scan session, high-resolution T1-weighted (magnetization-prepared rapid-acquisition gradient echo) anatomical images are collected [e.g., TR, 1900 ms; TE, 2.98 s; flip angle 9°; 160 sagittal slices 1×1×1 mm]. Experimental runs and localizer runs are acquired using a gradient-echo echoplanar sequence [e.g., repetition time (TR), 2 secs; echo time (TE), 30 ms; flip angle, 90°; 40 slices; 3×3×3 mm]. Stimuli are presented on a computer and displayed on a rear projection system via a mirror attached to a 32-channel head coil. Manual responses are collected using a Mag Design and Engineering four-button response pad and recorded using Psychophysical Toolbox (Brainard, 1997; Kleiner et al., 2007) running within Matlab, E-Prime, and other data collection and presentation software. Those skilled in the art know that there can be other variations on the specific scanning parameters and such variations are considered as covered by the appended claims.

In one embodiment, the fMRI data is analyzed using, in one example, SPM8 (a version of a particular Statistical Parametric Mapping software program). The following procedure can also be conducted using, for example, SPM5, Brain Voyager, AFNI, FSL, Freesurfer, or any functional MRI preprocessing or analysis software. During preprocessing stages, functional images are corrected for differences in slice time acquisition by resampling all slices to match the first slice. Using sinc interpolation, images are motion corrected across all runs. The functional data is then normalized (based on, for example, the Montreal Neurological Institute MNI or Talairach stereotaxic space) and if smoothed, smoothed with an 8 mm or 6 mm full-width at half-maximum isotropic Gaussian kernel. Univariate data analysis is conducted under the assumptions of a general linear model. Multivariate analysis procedures may also be used to visualize and interpret the significance of the results.

Contrast overlays are created using, in one example, the SPM surfrend toolbox, and region of interest analysis are conducted using, in one example, the SPM marsbar toolbox (http://marsbar.sourceforge.net/). Anatomical regions of interest are drawn using, in one example, MRICRON.

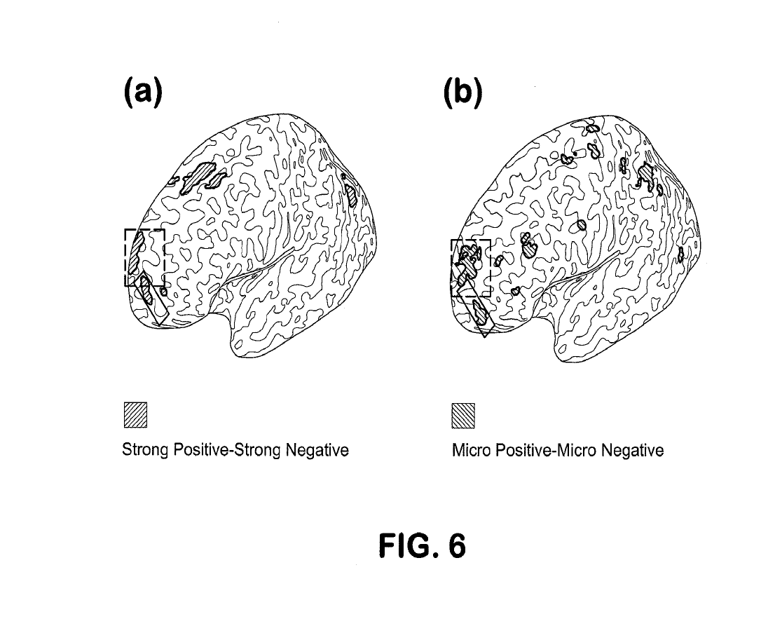

FIG. 6 presents activation threshold at p<0.05 for SP-SN in green (a) and MP-MN in purple (b) plotted on an inflated left hemisphere. The yellow box highlights the adjacency of activation for the strong and micro conditions in the inferior frontal sulcus and the orange box highlights a similar spatial relationship in a slightly more dorsal region of prefrontal cortex (PFC). In one example, in order to identify the regions involved in processing stimuli with a strong valence, the activation on strong negative trials is subtracted from strong positive trials (SP-SN). This reveals that the valence information is coded in the prefrontal cortex, indicated by the activation plotted in FIG. 6a. There are two notable clusters, one located in the inferior frontal sulcus, and the other located in a more dorsal portion of frontal polar cortex. The location of this activation shows that the representation of valence contributes to object perception via top down projections from prefrontal cortex. In one embodiment, when the same contrast for micro-valence (MP-MN) is repeated, activation is seen in an adjacent brain region (FIG. 6b). This activation falls adjacent to the location of the strong valence condition. This shows that micro-valence is coded by the same neural system that codes for objects with a strong valence. Table 1 below presents the peak activation for strong and micro-valence for each individual participant.

TABLE 1
Peak Activation for strong and micro-
valence for individual participants

| Participant | X | Y | Z | Size | t-value | Valence Strength |
|---|---|---|---|---|---|---|
| S1 | −36 | 54 | 30 | 14 | 4.02 | strong |
| S1 | −45 | 45 | 24 | 27 | 4.46 | micro |
| S2 | −3 | 63 | 27 | 147 | 5.5 | strong |
| S2 | −18 | 63 | 30 | 164 | 5.77 | micro |
| S3 | −33 | 66 | 12 | 683 | 5.54 | strong |
| S3 | −38 | 18 | −9 | 12 | 4.25 | micro |
| S4 | 3 | 63 | 30 | 16 | 4.66 | strong |
| S4 | 6 | 63 | 12 | 6 | 3.31 | micro |
| S5 | −42 | 53 | 9 | 1013 | 9.08 | strong |
| S5 | n/a | n/a | n/a | n/a | n/a | micro |
| S6 | −18 | 51 | 15 | 29089 | 11.38 | strong |
| S6 | 15 | 57 | 27 | 6 | 3.41 | micro |
| S7 | −15 | 69 | 21 | 132 | 6.24 | strong |
| S7 | −33 | 48 | 33 | 141 | 5.66 | micro |
| S8 | −18 | 57 | 8 | 7028 | n/a | strong |
| S8 | −27 | 60 | 24 | 355 | 6.15 | micro |
| S9 | 9 | 54 | −3 | 371 | 5.09 | strong |
| S9 | −33 | 68 | 21 | 12 | 3.8 | micro |
| S10 | −6 | 60 | 3 | 89 | 4.05 | strong |
| S10 | 27 | 63 | −9 | 5 | 3.41 | micro |
| S11 | −18 | 66 | −6 | 3 | 4.1 | strong |
| S11 | −42 | 54 | −3 | 10 | 4.08 | micro |
| S12 | n/a | n/a | n/a | n/a | n/a | strong |
| S12 | −45 | 42 | 6 | 44 | 3.67 | micro |
| S13 | −18 | 63 | 21 | 245 | 6.32 | strong |
| S13 | −30 | 42 | −18 | 42 | 4.9 | micro |
| S14 | −3 | 63 | 18 | 18 | 3.54 | strong |
| S14 | −18 | 15 | −30 | 7 | 3.87 | micro |
| S15 | n/a | n/a | n/a | n/a | n/a | strong |
| S15 | −3 | 51 | −9 | 55 | 4.05 | micro |

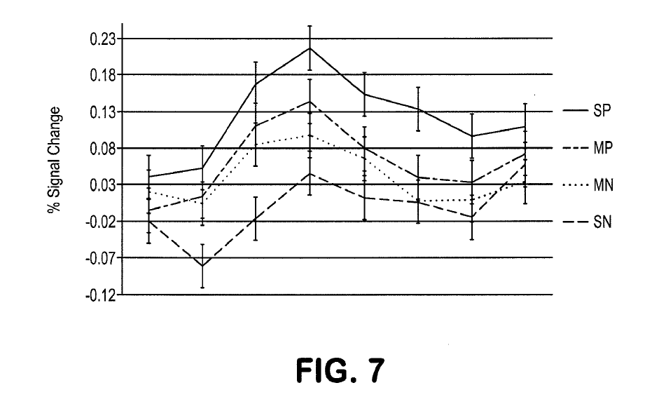

In one embodiment, a region of interest method is used to test whether the intensity of perceived valence operates on a continuum. Based on a priori predictions that the prefrontal cortex contributes to object recognition via top-down projections and the orbitofrontal cortex is engaged in value processing, an anatomical region of interest is drawn that encompasses the left prefrontal cortex. The results within this ROI indicate a continuum of valence. FIG. 7 graphs the time course activation for all four experimental conditions from an anatomically defined region of interest in left prefrontal cortex. The percent signal change is noted on the vertical axis and the horizontal axis represents the progression of time. It is important to note that the peak of the response of the Hemodynamic Response Function (HRF) is the strongest for most positive and gets progressively less as the valence changes from strongly positive to strongly negative. There is a significant linear trend across the four conditions valence strengths [F (1, 14)=12.88, p=0.0002] computed from the integrated percent signal change.

The time course shown in FIG. 7 illustrates the strongest activation for objects with a strong positive valence, followed by micro-positive, micro-negative, and the weakest activation for objects with a strong negative valence. The integrated percent signal change for the average response for each of the valences and valence strengths (e.g. SP, SN, MP, & MN) demonstrate a significant linear trend across valence and strength of valence [F (1, 14)=12.88, p=0.0002*].

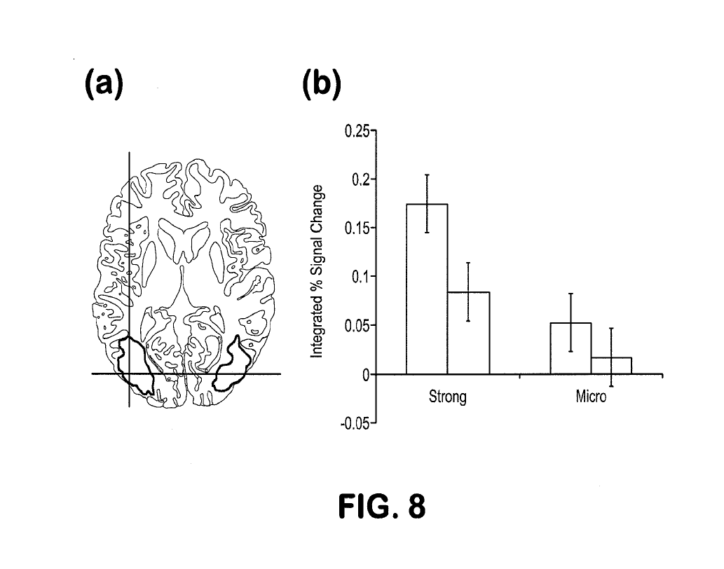

In one example, in the above experiment, the neural underpinnings of valence processing as they relate to object recognition are examined. In particular, the lateral occipital cortex (LOC) is known to be a key area in the processing of objects. As such, LOC responses are examined to determine whether or not they reflect any information pertaining to the valence of objects. A region of interest is selected from the functionally defined LOC (from the objects minus scrambled group map). FIG. 8 shows the location of the Lateral Occipital Cortex (LOC) cluster (a) defined from an objects-scrambled localizer (peak MNI coordinate −42, −78, 9) that is used in the Region of Interest (ROI) analysis presented in (b). The graph of activation from the ROI shows a main effect of valence [F (1, 14)=8.50, p=0.001*], demonstrating that the LOC can distinguish between objects of different valences. This is also a main effect of strength [F (1, 14)=7.25, p=0.001*], whereby activation is stronger for objects with a stronger valence.

The results in FIG. 8 show that neurons in the LOC do distinguish between positive and negative objects, indicated by a main effect of Valence [F (1, 14)=8.50, p=0.001*]. Moreover, the responses in LOC are greater for objects with a strong valence as shown by a main effect of Strength [F (1, 14)=7.25, p=0.001*]. At the same time, there is no significant Valence×Strength interaction.

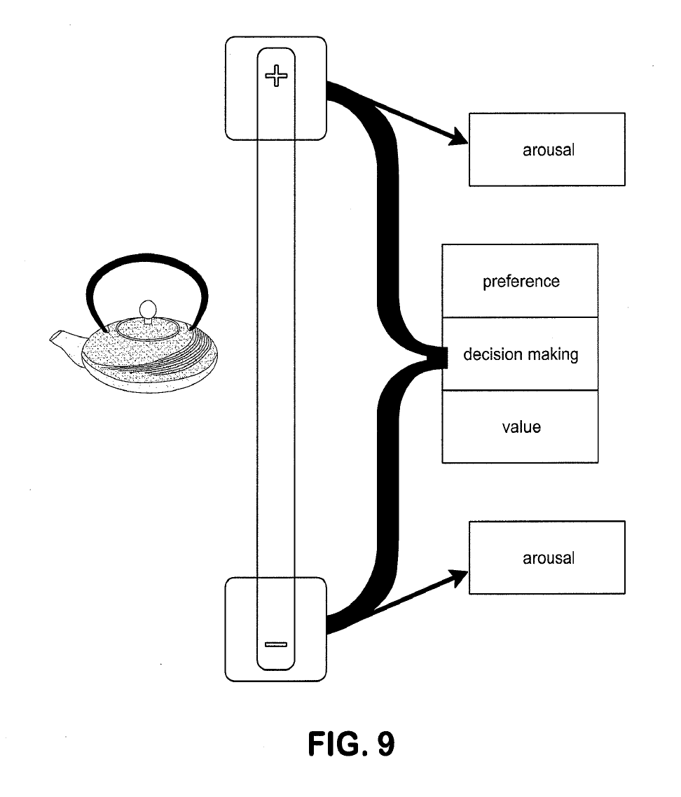

FIG. 9 illustrates how the valence perceived during object recognition relates to decision-making and arousal. We show that all valence metrics generated during perception can feed forward into choice and decision-making systems, regardless of their strength value. However, only valences that exceed a particular strength magnitude are projected to the arousal system and generate a complete affective response.

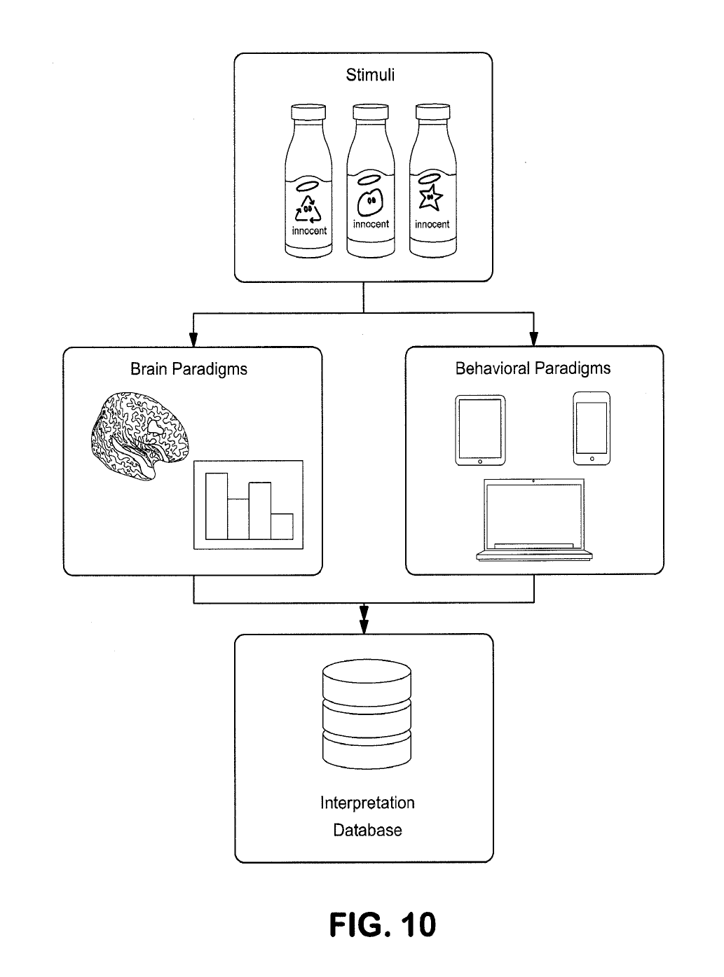

FIG. 10 illustrates a process for using various paradigms and stimuli to organize and analyze data pertaining to consumer preferences.

While the neuroimaging techniques have been described primarily in terms of embodiments using behavioral tasks, those skilled in the art will recognize that the methods of the present invention could also be used in EEG, MEG, NIRS, and eye-tracking, as well as other, non-neural, physiological measures, and all such techniques are considered to be encompassed in the appended claims.

Traditional models of affective perception assume that the visual system recognizes an object and then the affective system assigns it a label indicating positive or negative. Even recent studies divide sensory perception into “tier one” and affective labeling to “tier two”. A problem with such sequential processing models is that they do not explain how the affective system “knows” to assign an affective label to the object in the first place. It is almost as if these models assume there is a homunculus deciding whether objects should be affective or not. In contrast, the Applicant has shown that valence is actually a featural dimension of perception, and that all objects are automatically evaluated for valence during perception (FIGS. 1 and 9).

In one example, a data presentation toolbox allows investigators to collect data regarding the valence and micro-valence of stimuli in a variety of functional neuroimaging and behavioral paradigms. This toolbox allows investigators to input their own stimuli into pre-defined paradigms.

In one example, a software analysis toolbox is used where users can enter in their own stimuli and compare the effectiveness of each stimuli based on a score that the software computes from the experimental signal.

In one example, a database containing a variety of information derived from a range of valence and micro-valence experiments provides a tool for data interpretation (FIG. 10).

In one example, behavioral experiments are performed where participants have virtual money or currency but in limited amounts and they are asked to choose what options to spend their currency on.

In one example, the experiments can be used to ascertain two critical aspects of visual trademarks: valence and distinctiveness. With respect to the former, trademarks, independent of their role as indicia, may be perceived as positive or negative in and of themselves. As such, entities employing trademarks desire indicia that convey positive valence that is then transferred to the entity or product itself. With respect to the latter, trademark law requires that indicia be either inherently distinctive or acquire distinctiveness over time. In either instance, this is a perceptual and cognitive question that can only be addressed by appropriate psychological and neuroscientific testing as to how perceivers relate the indicia in question relative to other indicia in the marketplace. Moreover, trademarks may be rendered far more protected in trademark disputes if the trademark holder has previously established during creation of the mark that it is treated as distinctive from both psychological and neuroscientific perspectives. Thus, these tools may be employed during trademark development, during promotion, and during life-time product marketing, all directed at consumers or relevant target audiences.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

The claimed system can be embodied using a processing system, such as a computer, having a processor and a display, input devices, such as a keyboard, mouse, microphone, or camera, and output devices, such as speakers, hard drives, and the like. This system comprises means for carrying out the functions disclosed in the claims (Means for exposing, means for calculating, means for storing, means for providing, means for correlating, etc.).

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention. Further, although the present invention has been described with respect to specific preferred embodiments thereof, various changes and modifications may be suggested to one skilled in the art and it is intended that the present invention encompass such changes and modifications as fall within the scope of the appended claims.

We claim:

1. A method for measuring response to stimuli, comprising:
exposing at least one individual, via a processing device, to at least one valence-measuring paradigm in which the at least one individual is exposed to a plurality of stimuli and is required to provide a response directed to at least one of said plurality of stimuli;
calculating a valence value for each of said plurality of stimuli based on each response; and
storing each valence value in a storage medium, wherein said response and a speed within which said response was given enables an inference to be made regarding an implicit attitude of the individual towards said at least one of said plurality of stimuli.

2. The method of claim 1, wherein said response is a spontaneous response.

3. The method of claim 1, wherein the stored valence values are used to predict how individuals will react to being exposed to stimuli to which they may not have been previously exposed.

4. The method of claim 1, wherein said at least one individual is exposed, via a processing device, to multiple valence-measuring paradigms, in each of which the at least one individual is exposed to a plurality of stimuli and provides a response directed to at least one of said plurality of stimuli;
calculating a valence value for each of said plurality of stimuli based on each response; and
storing each valence value in a storage medium.

5. The method of claim 4, comprising a first valence-measuring paradigm that includes a behavioral valence measuring technique and a second valence measuring paradigm that includes a neuroimaging valence measuring technique.

6. The method of claim 5, wherein valence values for a particular one of said stimuli for each of said paradigms are correlated, thereby providing a basis for assessing a confidence level of the valence values for said particular one of said stimuli.

7. The method of claim 5, wherein the correlated valence values are used to give a distributed representation of valence.

8. The method of claim 1, wherein said at least one valence-measuring paradigm comprises a behavioral valence measuring technique.

9. The method of claim 1, wherein said at least one valence-measuring paradigm comprises a neuroimaging valence measuring technique.

10. The method of claim 1, further comprising:
creating, using said valence values, a model to predict general individual behavior related to exposure to stimuli comprising a product.

11. The method of claim 1, wherein said at least one valence-measuring paradigm measures a positive dimension of valence.

12. The method of claim 1, wherein said at least one valence-measuring paradigm measures a negative dimension of valence.

13. A system for measuring response to stimuli, comprising:
means for exposing at least one individual, via a processing device, to at least one valence-measuring paradigm in which the at least one individual is exposed to a plurality of stimuli and is required to provide a response directed to at least one of said plurality of stimuli;
means for calculating a valence value for each of said plurality of stimuli based on each response; and
means storing each valence in a non-transitory storage medium, wherein said response and a speed within which said response is given enables an inference to be made regarding an implicit attitude of the individual towards said at least one of said plurality of stimuli.

14. The method of claim 13, wherein said response is a spontaneous response.

15. The system of claim 13, wherein the stored valence values are used to predict how individuals will react to being exposed to stimuli to which they may not have been previously exposed.

16. The system of claim 13, further comprising:
means for exposing said at least one individual to multiple valence-measuring paradigms, in each of which the at least one individual is exposed to a plurality of stimuli;
means for providing a response directed to at least one of said plurality of stimuli;
means for calculating a valence value for each of said plurality of stimuli based on each response; and
means storing each valence value in a non-transitory storage medium.

17. The system of claim 16, further comprising a processing device configured with a first valence-measuring paradigm that includes a behavioral valence measuring technique and a second valence measuring paradigm that includes a neuroimaging valence measuring technique.

18. The system of claim 17, further comprising:
means for correlating valence values for a particular one of said stimuli for each of said paradigms, thereby providing a basis for assessing a confidence level of the valence values for said particular one of said stimuli.

19. The system of claim 18, wherein the correlated valence values are used to give a distributed representation of valance.

20. The system of claim 13, wherein said at least one valence-measuring paradigm comprises a behavioral valence measuring technique.

21. The system of claim 13, wherein said at least one valence-measuring paradigm comprises a neuroimaging valence measuring technique.

22. The system of claim 13, further comprising:
means for creating, using said valence values, a model to predict general individual behavior related to exposure to stimuli comprising a consumer product.

23. The system of claim 13, wherein said at least one valence-measuring paradigm measures a positive dimension of valence.

24. The system of claim 13, wherein said at least one valence-measuring paradigm measures a negative dimension of valence.
